(19) United States
(12) Patent Application Publication
(10) Pub. No.: US 2011/0163141 A1
(43) Pub. Date: Jul. 7, 2011

(54) Apparatus for On-Board Storage of Electric Vehicle Charging Cord

(75) Inventors: Marc Jonathon Lucas, Novi, MI (US); Kip Alan Ewing, Bloomfield Hills, MI (US); Julie D'Annunzio, Livonia, MI (US)

(73) Assignee: FORD GLOBAL TECHNOLOGIES, LLC, Dearborn, MI (US)

(21) Appl. No.: 12/913,421

(22) Filed: Oct. 27, 2010

(51) Int. Cl. B60R 7/08; B60R 11/00

(52) U.S. Cl. 224/496; 224/547

(57) ABSTRACT

An electric charging cord is stored aboard an automotive vehicle using a cord storage unit that has at least one mounting feature. A bracket is positioned on an interior of a movable body closure, such as a hatch-back, and engages the mounting feature to removably attach the storage unit to the panel throughout movement of the body closure between open and closed positions. In a stowed position, the storage unit is held closely adjacent the body closure by a latch. When the body closure is in the raised/open position, the latch is released and the storage unit drops downward and hangs from the bracket where it may easily be removed from engagement with the bracket.

### BACKGROUND

1. Technical Field

The present invention relates to electrically powered automotive vehicles equipped with high voltage batteries that may be recharged from an off-board power source.

2. Background Art

Some types of electrically powered vehicles such as plug-in hybrids and battery electric vehicles use a charging cord to connect the vehicle to an off-board power supply when it is necessary to charge/re-charge the on-board batteries. It may be desirable to carry the charging cord on board the vehicle and, if this is the case, it is desirable to ensure that the vehicle operator has secure storage and easy access to the cord when needed. If the charging cord is stored loose in the trunk or other cargo compartment of the vehicle, there is a risk that it may become a hazard during a collision. Also, it may be difficult to find when needed, particularly if there are other objects in the trunk or cargo compartment that may be hiding or blocking access to the cord. If the charging cord is stored in a compartment within the vehicle cargo compartment, access to the storage compartment may be blocked by other objects and so require removal of those other objects in order to reach the charging cord.

### SUMMARY

In a first disclosed embodiment, apparatus for storing an electric charging cord aboard an automotive vehicle comprises a cord storage unit comprising a cord retaining portion and at least one mounting feature, and a bracket disposed on an interior of a movable body closure and engaging the mounting feature to removably attach the storage unit to the panel throughout movement of the body closure between and including open and closed positions.

In a further disclosed embodiment, apparatus for storing a electrical cord aboard an automotive vehicle comprises a vehicle body closure movable between a lowered/closed position and an open/raised position, a cord storage unit comprising a cord retaining portion and at least one mounting feature, and a bracket mounted to an interior of the body closure and matingly engaging the mounting feature to removably attach the cord storage unit to the body closure.

In a further disclosed embodiment, apparatus for storing an electrical cord aboard an automotive vehicle having an upwardly-opening tailgate comprises a cord storage unit comprising a cord retaining portion and at least one mounting feature, and a bracket securable to an interior of the tailgate and engaging the mounting feature to removably attach the cord storage unit to the tailgate throughout a range of motion of the tailgate including and between a lowered/closed position and a raised/open position.

### BRIEF DESCRIPTION OF THE DRAWINGS

Embodiments of the present invention will now be described by way of example only with reference to accompanying drawings in which:

FIG. 1 is a schematic view of a vehicle with a charging cord storage unit mounted to a tailgate;

FIG. 2 is a schematic side view of a rear portion of a vehicle equipped with a charging cord storage unit similar to that shown in FIG. 1;

FIG. 3 is a schematic perspective view of a charging cord storage unit;

FIG. 4 is a schematic perspective view of a charging cord storage bracket; and

FIG. 5 is a schematic perspective view of the charging cord storage unit of FIG. 3 mounted on the bracket of FIG. 4.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

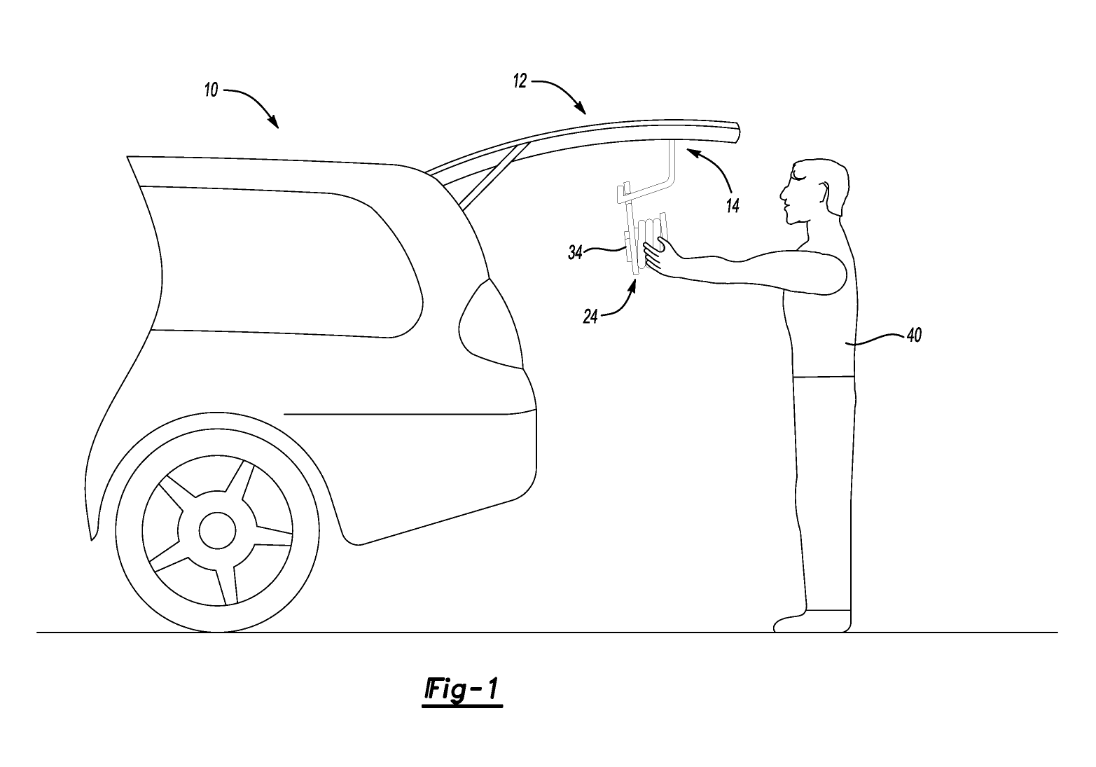

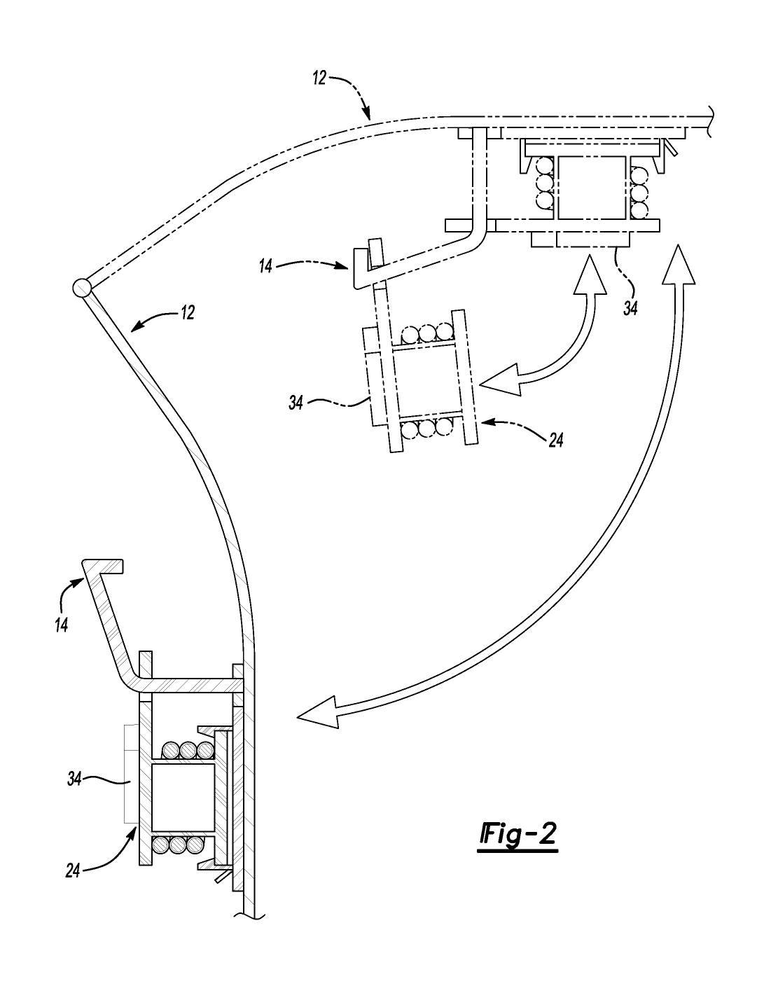

Referring to FIG. 1 an automotive vehicle 10 has a body closure 12 shown in a raised or open condition. Body closure 12 is, as is well known in the automotive arts, moveable between the raised/open position shown and a close/lowered condition as indicated in FIG. 2.

A charging cord mounting and storage bracket 14 is mounted to an interior surface of the closure 12. The interior surface of the closure 12 may be the primary metal structure of the closure and/or trim panels formed of plastic or other appropriate materials. Bracket 14 may be mounted to the interior surface by any appropriate means, such as bolts, self tapping screws, welding or Christmas tree fasteners.

Bracket 14 comprises one or more retaining arms 16 and a latch mechanism 18 comprising upper and lower latch fingers 20 and a release tab 22.

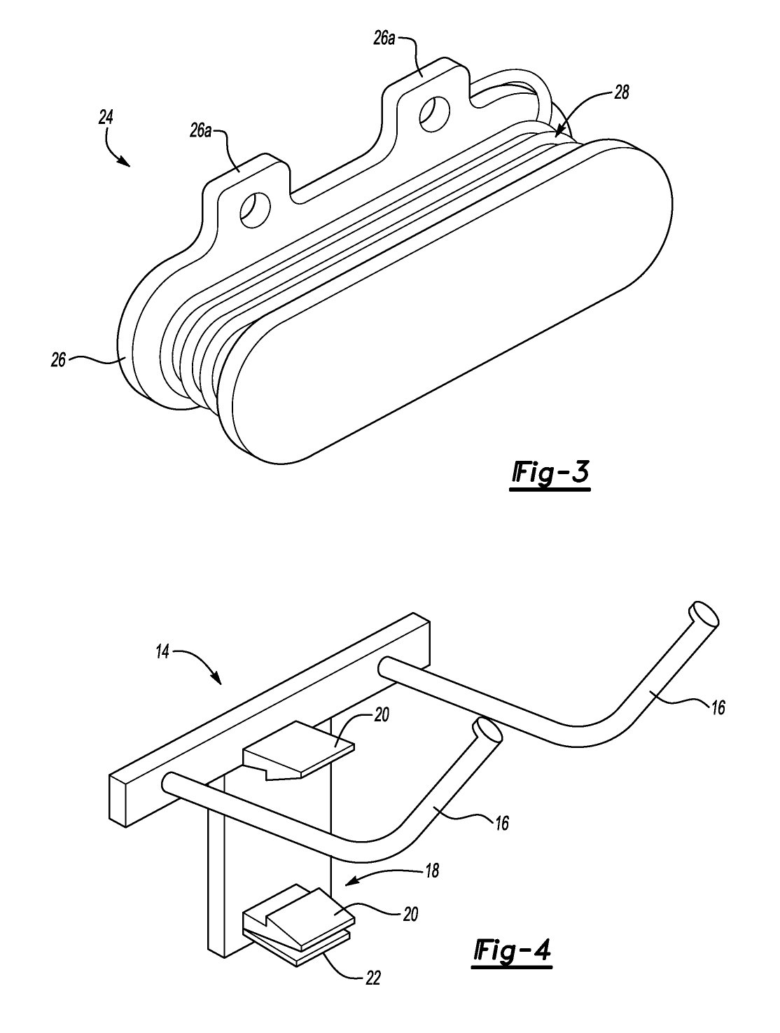

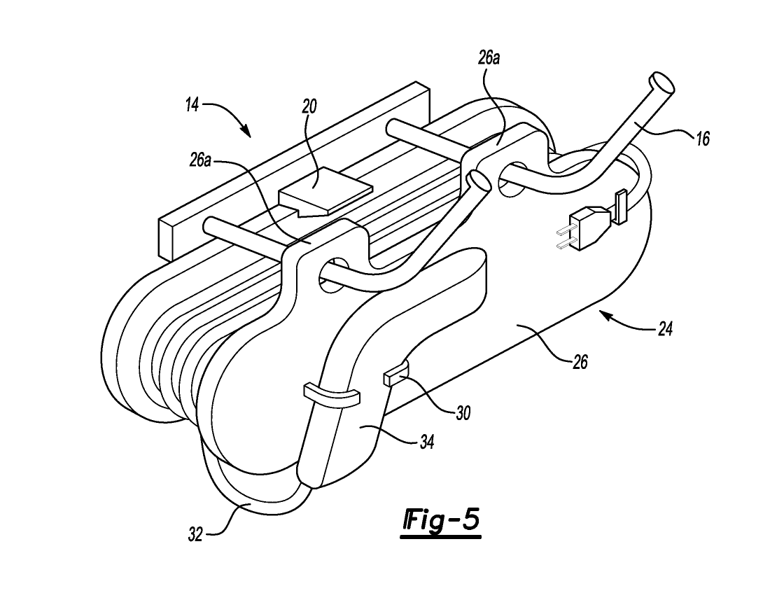

A cord storage unit 24, as best seen in FIG. 3, comprises a mounting plate 26, a central spool 28 and a connector retainer 30. Charging cord 32 is wrapped around the spool 28 for storage and a vehicle coupler 34 is held by the coupler retainer 30. Charging cord 32 may include a ground fault circuit interrupter (not shown).

As indicated in FIG. 2, when in the stored condition storage unit 24 is placed in engagement with bracket 14 so that holes in the mounting tab 26a engage arm 16 of the bracket and latch fingers 20 are snapped into engagement with upper and lower edges of mounting plate 26.

Latch fingers 20 are spring loaded to the latch condition and hold storage unit 24 securely in the stowed position closely adjacent to the body closure 12 throughout the full range of motion of the closure between the lowered/closed position and the raised/open position. When the operator 40 requires access to the charging cord he/she moves the closure 12 to the open/raised condition and actuates the release tab 22 thereby releasing the latch fingers 20 from engagement with mounting plate 26 of storage unit 24. This allows the entire storage unit 24 to drop downwardly, under the force of gravity, and slide along arms 16 to the access position shown in FIG. 2.

Operator 12 then may lift and/or rotate the storage unit 24 to disengage the mounting features 26a from arm 16 thereby completely freeing storage unit 24 from bracket 14. Power cord 32 is then uncoiled from storage unit 24 and the ends of the power cord connected with the vehicle 10 and an appropriate power source to recharge the vehicle batteries.

When charging is complete, power cord 32 is wrapped around spool 28, the coupler 34 placed in engagement with coupler retainer 30, and the mounting ears 26a engaged with arms 16 so that storage unit 24 is once again hanging from bracket 14 with closure 12 in the open/raised position. Operator 40 then moves/rotates/slides storage unit 24 upwardly to place mounting plate 26 between latch fingers 20 and urges the storage unit upward so that latch fingers 20 snap into engagement with the mounting plate. Closure 12 may then be returned and latched in the lower/closed position.

It is also possible for the operator 40 to lower closure 12 to its closed position immediately after hanging storage unit 24 from bracket arms 16, without first moving the storage unit into engagement with latch fingers 20. When closure 12 is moved to its closed position, storage unit 24 will swing into contact with bracket 14 and inertia will cause mounting plate 26 to snap into engagement with latch fingers 20.

Cord storage unit 24 is held securely in the stowed position with no danger of moving during a collision or of being lost or buried underneath or behind other objects carried in the vehicle cargo compartment.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed:

1. Apparatus for storing an electric charging cord aboard an automotive vehicle comprising:
a cord storage unit comprising a cord retaining portion and at least one mounting feature; and
a bracket disposed on an interior of a movable body closure and engaging the mounting feature to removably attach the storage unit to the panel throughout movement of the body closure between and including open and closed positions.

2. The apparatus according to claim 1 further comprising a latch holding the storage unit in a stowed position relative to the bracket, the latch releasable to allow the storage unit to be removed from engagement with the bracket.

3. The apparatus according to claim 2 wherein the latch is manually releasable by an operator.

4. The apparatus according to claim 2 wherein in the stowed position the storage unit is held closely adjacent the body closure by the latch and release of the latch allows the storage unit to move away from the body closure to an access position when the body closure is in the open position.

5. The apparatus according to claim 4 wherein the body closure is an upwardly-opening tailgate that when in the open position is generally horizontal and the storage unit when in the access position hangs downwardly from the interior surface of the body closure.

6. The apparatus according to claim 1 wherein the cord storage unit further comprises a retainer for securing a coupler terminating the cord to the cord storage unit.

7. The apparatus according to claim 1 wherein the cord retaining portion comprises a spool having an outer surface for receiving the cord in a wrapped condition.

8. Apparatus for storing an electrical cord aboard an automotive vehicle comprising:
a vehicle body closure movable between a lowered/closed position and an open/raised position;
a cord storage unit comprising a cord retaining portion and at least one mounting feature; and
a bracket mounted to an interior of the body closure and matingly engaging the mounting feature to removably attach the cord storage unit to the body closure.

9. The apparatus according to claim 8 further comprising a latch engaging the cord storage unit to hold it in a stowed position relative to the bracket, the latch releasable to allow the storage unit to move to an access position.

10. The apparatus according to claim 9 wherein the latch is manually releasable by an operator.

11. The apparatus according to claim 8 wherein in the stowed position the storage unit is held closely adjacent the body closure by the latch, and in the access position the storage unit hangs away from the body closure when the body closure is in the open/raised position.

12. The apparatus according to claim 8 wherein the cord storage unit further comprises a retainer for securing a coupler terminating the cord in a storage position relative to the cord storage unit.

13. The apparatus according to claim 8 wherein the cord retaining portion comprises a spool having an outer surface for receiving the cord in a wrapped condition.

14. Apparatus for storing an electrical cord aboard an automotive vehicle having an upwardly-opening tailgate comprising:
a cord storage unit comprising a cord retaining portion and at least one mounting feature; and
a bracket securable to an interior of the tailgate and engaging the mounting feature to removably attach the cord storage unit to the tailgate throughout a range of motion of the tailgate including and between a lowered/closed position and a raised/open position.

15. The apparatus according to claim 14 wherein the bracket further comprises a latch engaging the cord storage unit to hold it in a stowed position relative to the body closure, the latch releasable to allow the storage unit to be removed from the bracket.

16. The apparatus according to claim 14 wherein the latch is manually releasable by an operator.

17. The apparatus according to claim 15 wherein in the stowed position the storage unit is held closely adjacent the tailgate by the latch, and release of the latch allows the storage unit to hang downwardly from the bracket in an access position when the tailgate is in the raised/open position.
